(19) United States
(12) Patent Application Publication
(10) Pub. No.: US 2025/0357491 A1
(43) Pub. Date: Nov. 20, 2025

(54) ELECTRODE FOR ALL-SOLID-STATE BATTERY AND ALL-SOLID-STATE BATTERY INCLUDING THE SAME

(71) Applicants: Hyundai Motor Company, Seoul (KR); Kia Corporation, Seoul (KR)

(72) Inventors: Dong Hyun Kim, Hwaseong (KR); Jae Hyun Rim, Hwaseong (KR); Yoon Jae Han, Hwaseong (KR); Chang Young Choi, Hwaseong (KR); Sang Mo Kim, Hwaseong (KR); Yoon Gon Kim, Hwaseong (KR)

(21) Appl. No.: 18/926,511

(22) Filed: Oct. 25, 2024

(30) Foreign Application Priority Data
May 14, 2024 (KR) 10-2024-0063475

(51) Int. Cl. H01M 4/62; H01M 4/02; H01M 4/04; H01M 4/36; H01M 10/04

(52) U.S. Cl. CPC H01M 4/628; H01M 4/0404; H01M 4/0435; H01M 4/366; H01M 4/625; H01M 10/0481; H01M 2004/021

(57) ABSTRACT

Provided is an electrode for an all-solid-state battery, featuring a current collector, a first coating layer formed on the current collector, and a second coating layer selectively applied to a partial region of the first coating layer. This design optimizes pressure distribution during battery assembly and operation, reducing surface degradation and preventing dendrite formation. Additionally, a conductive material layer is formed on a partial region of the second coating layer to enhance electrical conductivity between the second coating layer and the solid electrolyte. The invention also includes methods for preparing the electrode and assembling the all-solid-state battery, which involves placing a pressing member on regions of the electrode lacking the second coating layer. The disclosed electrode structure significantly improves the performance, durability, and safety of all-solid-state batteries.

### CROSS-REFERENCE TO RELATED APPLICATION

This application claims under 35 U.S.C. § 119(a) the benefit of Korean Patent Application No. 10-2024-0063475, filed in the Korean Intellectual Property Office on May 14, 2024, the entire contents of which are incorporated herein by reference.

### BACKGROUND

### Technical Field

The present disclosure relates to an electrode for an all-solid-state battery, featuring a novel structure designed to enhance the overall performance of the all-solid-state battery. This improvement is achieved by minimizing electrode surface degradation and dendrite formation during the rolling pressing process. Specifically, a thinner coating layer is selectively applied only in regions where pressure is concentrated during this process, while a conductive material layer is formed on partial regions of the second coating layer to enhance electrical conductivity between the second coating layer and the solid electrolyte. The disclosure also includes methods for preparing the electrode and assembling the all-solid-state battery, along with a pressing member strategically placed on regions of the electrode that lack the second coating layer to further optimize battery performance and durability.

### Background

Recently, studies and researches have been conducted on various batteries to overcome the limitation of a lithium secondary battery in the capacity of a battery, the stability of the battery, the power of the battery, the increase in the size of the battery, or the decrease in the size of the battery. Among them, the all-solid-state battery refers to a battery having a solid electrolyte instead of a liquid electrolyte having been employed in a conventional lithium secondary batteries. According to the all-solid-state battery, as a flammable solvent is not used inside the battery, the risk of firing or explosion, which has occurred due to the decomposition reaction of the conventional electrolyte, is removed, so stability is significantly improved.

The all-solid-state battery is prepared by forming a stack structure including a positive electrode, a negative electrode, and a solid electrolyte interposed between the positive electrode and the negative electrode, and then rolling-pressing the stack structure. In detail, the all-solid-state battery needs to be operated while maximizing contact in the interface between the positive electrode and the solid electrolyte and the interface between the solid electrolyte and the negative electrode. Accordingly, the all-solid-state battery is driven while maintaining higher pressure applied to the stack structure.

One of the most extensively used manners for applying higher pressure during driving is to maintain the stack structure pressed using a pressing member such as a pressing jig. However, pressure may be unevenly applied due to the structure characteristic of the pressing member, such as the pressing jig, such that higher pressure is applied to a partial region. In addition, when the higher pressure is applied to the partial region, current-density concentration is caused in the partial region. Accordingly, the electrode surface may be degraded and the dendrite may be formed.

Accordingly, there is required an all-solid-state battery having a novel structure to minimize pressure deviation even if a stack structure is pressed by using an existing pressing member, thereby preventing the surface characteristic degradation, such that the durability and the performance of the all-solid-state battery are improved, and a method for preparing the same.

### SUMMARY

The present disclosure has been made to solve the above-mentioned problems occurring in the prior art while advantages achieved by the prior art are maintained intact.

An aspect of the present disclosure provides an electrode for an all-solid-state battery and a method for preparing the same, and an all-solid-state battery including the electrode for the all-solid-state battery, and a method for preparing the same.

Another aspect of the present disclosure provides an electrode for an all-solid-state battery, capable of unifying surface pressure during battery assembling and driving, by selectively excluding a second coating layer only in a region to be applied with pressure after the all-solid-state battery is assembled, such that the performance and the durability of the all-solid-state battery are improved, and a method for preparing the same, and an all-solid-state battery including the electrode for the all-solid-state battery, and a method for preparing the same.

The technical problems to be solved by the present disclosure are not limited to the aforementioned problems, and any other technical problems not mentioned herein will be clearly understood from the following description by those skilled in the art to which the present disclosure pertains.

To solve the above problems, the present disclosure provides an electrode for an all-solid-state battery, the all-solid-state battery including the same, a method for preparing the electrode for the all-solid-state battery, and a method for preparing the all-solid-state battery.

In some embodiments, an electrode for an all-solid-state battery includes a current collector, a first coating layer formed on the current collector, and a second coating layer formed on a partial region of the first coating layer. The electrode may have a region with the first coating layer that is surrounded by the second coating layer. The ratio of the thickness of the second coating layer to the thickness of the first coating layer may range from about 1% to 5%. Additionally, the ratio of the area of the region with the second coating layer to the area of the region with the first coating layer may range from about 60% to 90%. The loading level of the electrode active material in the second coating layer may be at least about 2% of the loading level in the first coating layer. Both the first and second coating layers may comprise an electrode active material, a binder, and a solid electrolyte. A pressing member may be placed on a region of the electrode that lacks the second coating layer.

In some embodiments, an all-solid-state battery includes an electrode as described above and a solid electrolyte. The battery may further include a conductive material layer formed on a partial region of the second coating layer, where the conductive material layer is configured to enhance the electrical conductivity between the second coating layer and the solid electrolyte. The conductive material layer may comprise materials such as carbon black, conducting graphite, ethylene black, or graphene and may be selectively formed only in regions of the second coating layer that are in direct contact with the solid electrolyte layer. The solid electrolyte layer is positioned between the electrode and an opposite electrode, and a pressing member may be used to apply pressure to the electrode, where the pressing member is placed on the region that lacks the second coating layer.

In some embodiments, a method for preparing an electrode for an all-solid-state battery involves forming a first coating layer on a current collector, placing a mask on the first coating layer, forming a second coating layer, and then removing the mask. The mask may comprise materials such as polyethylene, polytetrafluoroethylene, or polyethylene naphthalate and may have a thickness ranging from about 5 μm to 50 μm. The method may involve coating and drying a first coating layer slurry comprising an electrode active material, a conductive material, a binder, and a solid electrolyte on the current collector, followed by coating and drying a second coating layer slurry with similar components.

In some embodiments, a method for preparing an all-solid-state battery includes sequentially stacking the described electrode, a solid electrolyte layer, and an opposite electrode, followed by rolling the stack structure using a pressing member. The pressing member may be placed on a region of the electrode that lacks the second coating layer. The electrode for the all-solid-state battery may serve as either a positive or a negative electrode, with the opposite electrode being the corresponding negative or positive electrode.

More specifically, (1) the present disclosure provides the electrode for the all-solid-state battery which includes a current collector, a first coating layer formed on the current collector, and a second coating layer formed on a partial region of the first coating layer.

(2) The present disclosure provides the electrode for the all-solid-state battery, in which a region, which has no second coating layer, of a region having the first coating layer is surrounded by a region having the second coating layer in (1).

(3) The present disclosure provides the electrode for the all-solid-state battery, in which a ratio of a thickness of the second coating layer to a thickness of the first coating layer is in a range from 1% to 5% in (1) or (2).

(4) The present disclosure provides the electrode for the all-solid-state battery, in which a ratio of an area of the region having the second coating layer to an area of the region having the first coating layer is in a range from 60% to 90% in any one of (1) to (3).

(5) The present disclosure provides the electrode for the all-solid-state battery, in which a ratio of a loading level of an electrode active material of the second coating layer to a loading level of an electrode active material of the first coating layer is at least 2% in any one of (1) to (4).

(6) The present disclosure provides the electrode for the all-solid-state battery, in which the first coating layer includes an electrode active material, a binder, and a solid electrolyte in any one of (1) to (5).

(7) The present disclosure provides the electrode for the all-solid-state battery, in which the second coating layer includes an electrode active material, a binder, and a solid electrolyte in any one of (1) to (6).

(8) The present disclosure provides the electrode for the all-solid-state battery and a solid electrolyte layer according to any one of (1) to (7).

(9) The present disclosure provides a method for preparing an electrode for an all-solid-state battery, in which the method forming a first coating layer on a current collector (S1), placing a mask on the first coating layer and forming a second coating layer (S2), and removing the mask (S3).

(10) The present disclosure provides a method for preparing an electrode for the all-solid-state battery, in which the mask includes at least one material selected from the group consisting of polyethylene, polytetrafluoroethylene, and polyethylene naphthalate.

(11) The present disclosure provides the method for preparing the electrode for the all-solid-state battery, in which the mask has a thickness ranging from 5 μm to 50 μm in (9) or (10).

(12) The present disclosure provides the method for preparing the electrode for the all-solid-state battery, in which the S1 includes coating and drying first coating layer slurry including an electrode active material, a conductive material, a binder, and a solid electrolyte on the current collector in (9) to (11).

(13) The present disclosure provides the method for preparing the electrode for the all-solid-state battery, in which the S2 includes coating and drying second coating layer slurry including an electrode active material, a conductive material, a binder, and a solid electrolyte on the first coating layer in any one of (9) to (12).

(14) The present disclosure provides a method for preparing an all-solid-state battery, which includes sequentially stacking the electrode for the all-solid-state battery according to any one of (1) to (17), a solid electrolyte layer, and an opposite electrode, and rolling a stack structure using a pressing member, in which the pressing member is placed on a region having no second coating layer of the electrode for the all-solid-state battery.

(15) The present disclosure provides the method for preparing the all-solid-state battery, in which the electrode for the all-solid-state battery is a positive electrode, and the opposite electrode is a negative electrode in (14).

(16) The present disclosure provides the method for preparing the all-solid-state battery, in which the electrode for the all-solid-state battery is a negative electrode, and the opposite electrode is a positive electrode in (14).

As discussed, the method and system suitably include use of a controller or processer.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating the structure of an electrode for an all-solid-state battery prepared according to an embodiment of the present disclosure.

### DETAILED DESCRIPTION OF EMBODIMENTS

Hereinafter, the present disclosure will be described in more detail for the understanding of the present disclosure.

In this case, terms and words used in the present specification and the claims shall not be limitedly interpreted as commonly-used dictionary meanings, but shall be interpreted as to be relevant to the technical scope of the present disclosure based on the fact that the inventor may properly define the concept of the terms to explain the present disclosure in best ways.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although example embodiment is described as using a plurality of units to perform the example process, it is understood that the example processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

### Electrode for All-Solid-State Battery

The present disclosure provides an electrode for an all-solid-state battery, which includes a current collector, a first coating layer formed on the current collector, and a second coating layer formed on a partial region of the first coating layer.

The all-solid-state battery, which includes a positive electrode, a negative electrode, a solid electrolyte interposed between the positive electrode and the negative electrode, is driven while the stack structure is pressed to maximize the contact in an interlayer-interface. Accordingly, only when the performance of the electrode used in the all-solid-state battery is maintained while the electrode used in the all-solid-state battery is pressed, the all-solid-state battery may be maintained with superior performance for a specific period or more.

A conventional all-solid-state battery employs a pressing member, such as a jig, to apply pressure to the positive electrode and the negative electrode, such that the pressing state described above is maintained. However, such a pressing member applies pressure only to a region in contact with the pressing member. Accordingly, there is a limitation in uniformly applying pressure with respect to the whole area of the positive electrode/negative electrode.

To this regard, the present disclosure is to provide an electrode for the all-solid-state battery employing an existing commercial pressing member while forming a thinner coating layer only in a region for applying stronger pressure by the pressing member and forming a thicker coating layer in a region for applying weaker pressure, thereby canceling the difference in pressure made due to the difference in thickness between coating layers.

Hereinafter, components constituting the electrode for the all-solid-state battery according to the present disclosure will be described in more detail.

### Current Collector

The current collector serves as a base to provide electrical conductivity to the electrode while supporting an active material layer (coating layer) of the electrode. The current collector may include a material having conductivity and durability at a specific level.

More specifically, the current collector may have different materials depending on whether the electrode is the positive electrode or the negative electrode. For example, the current collector may include copper, stainless steel, aluminum, nickel, titanium, calcined carbon, or the above material which is surface-treated with carbon, nickel, titanium, or silver, and/or an aluminum-cadmium alloy. The current collector may have the form of a film, sheet, foil, net, porous body, foam, or nonwoven fabric to uniformly form an electrode active material layer on the surface of the current collector.

The current collector may have the thickness ranging from 8 μm to 25 μm, preferably 10 μm to 20 μm. When the thickness of the current collector is within the above-described range, the electrode may have more uniformly excellent durability and performance.

### First Coating Layer and Second Coating Layer

According to the present disclosure, the first coating layer and the second coating layer serve as electrode active material layers. The first coating layer is formed on the above current collector, and the second coating layer is formed on the first coating layer.

In the electrode for the all-solid-state battery according to the present disclosure, as the second coating layer is formed only in a partial region of the first coating layer, the first coating layer is formed in a portion of the electrode, and the stack structure of the first coating layer and the second coating layer is formed in a remaining region of the electrode.

Such a design of a coating-layer structure may be made to uniformly maintain pressure applied to the entire region of the electrode by forming the thinner coating layer only in the region for applying stronger pressure. The region for the second coating layer may be varied depending on a region of the electrode to be applied with pressure by a pressing member, which is to apply pressure to the electrode for the all-solid-state battery according to the present disclosure. For example, when the pressing member applies pressure to the central region of the electrode, the second coating layer may be formed in a remaining region of the electrode except for the central region of the electrode. In this case, a region, which has no second coating layer, of the first coating layer may be surrounded by the second coating layer.

The first coating layer and the second coating layer may be distinguished depending on the stacking order. The ratio of the thickness of the second coating layer to the thickness of the first coating layer may be in the range of 1% to 5%, preferably, the range of 2% to 3%. In addition, the thickness of the first coating layer may be in the range of 25 μm to 100 μm, preferably 28 μm to 98 μm, and more preferably 29 μm to 95 μm. In addition, the thickness of the second coating layer may be 0.1 μm to 5 μm, preferably 0.5 μm to 3 μm.

When the thicknesses of the first coating layer and the second coating layer satisfy the above condition, the issue of the pressure unevenly applied by the pressing member may be minimized and the contact in the interface between the solid electrolyte layer and the electrode active material layer may be maximized. When the second coating layer is excessive thicker than the first coating layer, the difference in height between a region having the second coating layer and a region having no second coating layer is excessively great, so the electrode may be cracked in the pressing process.

The ratio of the area of a region having the second coating layer to the area of a region having the first coating layer may be in the range of 60% to 90%, preferably, 70% to 80%. Although the area of the region having the second coating layer is varied depending on the structure shape of the pressing member, when the proportion of the area of the region having the second coating layer satisfies the above condition, the surface pressure may be more uniform in the pressing condition.

In the electrode for the all-solid state battery according to the present disclosure, the ratio of a loading level of the electrode active material of the second coating layer to a loading level of the electrode active material of the first coating layer may be 2% or less, preferably 1% or less. This is also related to the thickness ratio between the first coating layer and the second coating layer described above. When the loading level of the electrode active material of the second coating layer is excessively higher than that of the first coating layer, the durability of the electrode may be rather deteriorated.

Meanwhile, each of the first coating layer and the second coating layer may include electrode active materials, conductive materials, binders, and solid electrolytes. To minimize the resistance in the interface between the first coating layer and the second coating layer, the first coating layer and the second coating layer may include substantially the same components. More specifically, the first coating layer and the second coating layer may include the electrode active material, the conductive materials, the binders, and the solid electrolytes provided in the same type and an equal content.

When the first coating layer and the second coating layer include positive electrode active materials, the positive electrode active materials may be an oxide active material or a sulfide active material.

The oxide active material may be a rock salt type active material such as LiCoO₂, LiMnO₂, LiNiO₂, LiVO₂, Li₁₊ₓNi_{1/3}Co_{1/3}Mn_{1/3}O₂, a spinel type active material such as LiMn₂O₄, Li(Ni_{0.5}Mn_{1.5})O₄, a reverse spinel type active material such as LiNiVO₄, or LiCoVO₄, an olivine-type active material such as LiFePO₄, LiMnPO₄, LiCoPO₄, or LiNPO₄, a silicon-containing active material such as Li₂FeSiO₄, Li₂MnSiO₄, a rock salt type active material, such as LiNi_{0.8}Co(_{0.2-x})AlₓO₂(0<x<0.2), which is obtained by substituting a portion of the transition metal with a heterogeneous metal, a spinel-type active material, such as Li₁₊ₓMn_{2-x-y}MyO₄ (M is at least one of Al, Mg, Co, Fe, Ni, and Zn; 0<x+y<2), which is obtained by substituting a portion of the transition metal with a heterogeneous metal, or lithium titanate such as Li₄Ti₅O₁₂. The sulfide active material may be copper Chevrel, iron sulfide, cobalt sulfide, or nickel sulfide.

Meanwhile, when the first coating layer and the second coating layer include negative electrode active materials, the negative electrode active material may be a carbon active material or a metal active material.

The carbon active material may be graphite, such as mesocarbon microbeads (MCMB) and highly oriented graphite (HOPG), or amorphous carbon such as hard carbon, and soft carbon. The metal active material may be Al, Si, Sn, and an alloy containing at least one element of Al, Si, and Sn.

The binder contained in each of the first coating layer and the second coating layer is a component to bind ingredients included in the first and second coating layers and may include butadiene rubber (BR), nitrile butadiene rubber (NBR), hydrogenated nitrile butadiene rubber (HNBR), polyvinylidene difluoride (PVDF), polytetrafluoroethylene (PTFE), or carboxymethylcellulose (CMC).

The conductive material, which ensures electrical conductivity of the electrode active material layer, may be carbon black, conducting graphite, ethylene black, or graphene.

More specifically, the solid electrolyte may be an oxide-based solid electrolyte or a sulfide-based solid electrolyte, and preferably a sulfide-based solid electrolyte. The solid electrolyte may have a lithium ion conductivity of 0.3 mS/cm or more.

The sulfide-based solid electrolyte is not particularly limited, but may, include Li₂S—P₂S₅, Li₂S—P₂S₅—LiI, Li₂S—P₂S₅—LiCl, Li₂S—P₂S₅—LiBr, Li₂S—P₂S₅—Li2O, Li₂S—P₂S₅—Li2O—LiI, Li₂S—SiS₂, Li₂S—LiI, Li₂S—SiS2—LiBr, Li₂S—SiS₂—LiCl, Li₂S—SiS₂—B₂S₃—LiI, Li₂S—SiS₂—P₂—B₂—LiI, Li₂S₅—LiI, Li₂S—B₂S₃, Li₂S₂—ZmSn (where ‘m’ and ‘n’ are positive numbers, Z is one of Ge, Zn and Ga), Li₂S—GeS₂, Li₂S—SiS₂—Li3PO4, Li₂S—SiS₂—LiₓMO_{y} (where ‘x’ and ‘y’ are positive numbers, M is one of P, Si, Ge, B, Al, Ga, In), or Li₁₀GeP₂S₁₂.

### All-Solid-State Battery

The present disclosure provides an all-solid-state battery including the electrode for the all-solid-state battery described above.

More specifically, the present disclosure provides the all-solid-state battery including the electrode for the all-solid-state battery and a solid electrolyte layer. The solid electrolyte layer may be interposed between two different electrodes for the all-solid-state battery.

When the electrode for the all-solid-state battery is the positive electrode, the all-solid-state battery may include the positive electrode for the all-solid-state battery according to the present disclosure, the solid electrolyte layer, and a typical negative electrode. When the electrode for the all-solid-state battery is the negative electrode, the all-solid-state battery may include the negative electrode of the all-solid-state battery according to the present disclosure, the solid electrolyte layer, and a typical positive electrode.

When the electrodes for the all-solid-state battery are a positive electrode and a negative electrode, the all-solid-state battery may include the positive electrode and the negative electrode for the all-solid-state battery according to the present disclosure, and a solid electrolyte layer interposed between the positive electrode and the negative electrode.

The solid electrolyte layer may include the solid electrolyte, the binder, and the conductive material included in the coating layer described above. To minimize the resistance in the interface, the solid electrolyte, the binder, and the conductive material included in the solid electrolyte layer may be the same as those used in the first coating layer and the second coating layer described above.

Meanwhile, in the all-solid-state battery provided in the present disclosure, the thickness of the solid electrolyte layer may be preferably in the range of 20 μm to 50 μm. When the solid electrolyte layer has an excessively thin thickness, electric-short or electrolyte crack may be caused. When the solid electrolyte layer has an excessively thick thickness, ion conductivity and electron conductivity are lowered to cause the issue related to the cell performance and the stability.

### Method for Preparing Electrode for All-Solid-State Battery

The present disclosure provides a method for preparing the electrode for the all-solid-state battery. More specifically, the present disclosure provides the method for preparing the electrode for the all-solid-state battery including forming the first coating layer on the current collector (S1), placing a mask on the first coating layer and forming the second coating layer (S2), and removing the mask (S3).

S1, which is to form the first coating layer (active material layer) on the current collector in a typical method, may include coating and drying first coating layer slurry including the electrode active material, the conductive material, the binder, and the solid electrolyte on the current collector. The electrode active material, the conductive material, the binder, and the solid electrolyte may be identically applied with the above description.

In the S1, the mask may be placed on the first coating layer before forming the second coating layer after forming the first coating layer on the current collector. The mask is a device to prevent the second coating layer from being formed. Accordingly, the second coating layer may be selectively formed only in a region without the mask, instead of the region covered with the mask.

The shape of the mask is not particularly limited, and the region for placing the mask, may be a region for concentrating the pressure applied by the pressing member to be described below. More specifically, when the pressing member is a jig, the region for placing the mask may include a region for placing an axis of the jig.

The mask should be a material which is not wet or rusted by a solvent, and may be varied depending on the solvent to be employed. For example, the material may include at least one selected from the group consisting of polyethylene, polytetrafluoroethylene, and polyethylene naphthalate. The thickness of the mask may be preferably in the range of 5 μm to 50 μm. When the mask is excessively thick or thin, the second coating layer may not be smoothly formed.

In the S2, the second coating layer may be formed by coating and drying second coating layer slurry, which includes the electrode active material, the conductive material, the binder, and the solid electrolyte, on the first coating layer, which is similar to forming of the first coating layer. The conductive material, the binder, and the solid electrolyte, which are included in the second coating layer slurry, may be identically applied with the above description.

Through the S2, the electrode for the all-solid-state battery including the first coating layer and the second coating layer formed in the partial region may be prepared, and the all-solid-state battery may be prepared by utilizing the electrode.

### Method for Preparing All-Solid-State Battery

The present disclosure provides the method for preparing the all-solid-state battery using the electrode for the all-solid-state battery described above.

More specifically, the present disclosure provides the method for preparing the all-solid-state battery which includes sequentially stacking the above-described electrode for the all-solid-state battery, a solid electrolyte layer, and an opposite electrode, and rolling the stack structure using the pressing member. The pressing member is placed on a region, which has no second coating layer, of the electrode for the all-solid-state battery.

As described above, the second coating layer of the electrode for the all-solid-state battery according to the present disclosure may be formed in a region not to receive any pressure. Accordingly, the pressing member to apply pressure may be placed on a region having no second coating layer.

Meanwhile, in the method for preparing the all-solid-state battery according to the present disclosure, when the electrode for the all-solid-state battery is the positive electrode, the opposite electrode may be the negative electrode. When the electrode for the all-solid-state battery is the negative electrode, the opposite electrode may be the positive electrode. In addition, both the positive electrode and the negative electrode of the all-solid-state battery may be the electrode for the all-solid-state battery according to the present disclosure.

The pressing member is not particularly limited as long as the pressing member is used for rolling the all-solid-state battery, and may be, for example, a jig having multiple axes. The jig may be a four-axis, six-axis, nine-axis, or 12-axis jig. When the four-axis or six-axis jig is used as the jig, since pressure is concentrated at the center of the electrode, the region having no second coating layer may be the center of the electrode. When the nine-axis or 12-axis jig is used as the jig, a region having no second coating layer may be a region for placing the axis of the jig.

Hereinafter, an embodiment of the present disclosure will be described in more detail. However, the following embodiment is not provided only for the illustrative purpose, and the scope of the present disclosure is not limited thereto.

### Embodiment 1

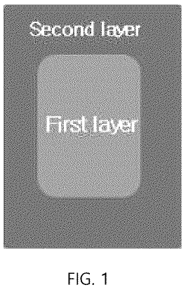

An NCM-based positive electrode active material, an azirodite-based solid electrolyte (LPSCl(Br)), and a butadiene rubber (BR) binder were mixed with an inorganic solvent to prepare a positive electrode slurry. The positive electrode slurry was applied and dried on the prepared aluminum current collector to form the first coating layer. Thereafter, the mask was placed on the first coating layer to form the second coating layer at a place as illustrated in FIG. 1. The positive electrode slurry was reapplied and dried to form the second coating layer. Thereafter, the positive electrode for the all-solid-state battery without the second coating layer at the center of the electrode was prepared by removing the mask.

According to the above process, the area of the used region of the mask was 25% of the area of the region having the first coating layer (the area of the region having the second coating layer was 75% of the area of the region having the first coating layer), and the thickness of the second coating layer was 2.1% of the thickness of the first coating layer formed above.

The negative electrode for the all-solid-state battery was prepared by using graphite, which is the negative electrode active material, instead of the positive electrode active material, which is identical to the positive electrode for the all-solid-state battery. The thickness of the prepared positive electrode for the all-solid-state battery was 100 μm and the thickness of the negative electrode for the all-solid-state battery was 50 μm. Solid electrolyte slurry was applied and dried on the prepared negative electrode to form the solid electrolyte layer on the negative electrode. The thickness of the solid electrolyte layer was 30 μm. The prepared positive electrode for the all-solid-state battery, the solid electrolyte layer, and the negative electrode for the all-solid-state battery was sequentially stacked and the stack structure was pressed by the six-axis jig to prepare the all-solid-state battery.

### Embodiment 2

The all-solid-state battery was prepared in the same manner as that of Embodiment 1, except that the thickness of the second coating layer is about less than 2% of the thickness of the first coating layer.

### Embodiment 3

The all-solid-state battery was prepared in the same manner as that of Embodiment 1, except that the area of the used region of the mask is less than 20% of the area of the region having the first coating layer.

### Embodiment 4

The all-solid-state battery was prepared in the same manner as that of Embodiment 1, except that the area of the used region of the mask is more than 30% of the area of the region having the first coating layer.

### Embodiment 5

The all-solid-state battery was prepared in the same manner as that of Embodiment 1, except that the mask was used only for the positive electrode, and not used for the negative electrode.

### Embodiment 6

The all-solid-state battery was prepared in the same manner as that of Embodiment 1, except that the mask was used only for the negative electrode, and not used for the positive electrode.

### Comparative Example

The all-solid-state battery was prepared, as the positive electrode, the negative electrode, and the solid electrolyte layer were formed to have equal thicknesses, sequentially stacked, and pressed by the same jig without the use of the mask in Embodiment 1.

The positive electrode and the negative electrode prepared in the Embodiments and the Comparative Examples are summarized in following Table 1. In the following Table 1, “gradation electrode” refers to an electrode prepared by using the mask.

TABLE 1

| | Positive electrode | | | Negative electrode | | |
|---|---|---|---|---|---|---|
| | Thickness (%) | | | Thickness (%) | | |
| | of second | | | of second | Area (%) of | |
| | coating | Area (%) of | | coating | mask to area | |
| | layer (%) to | mask to area | | layer to | of first | |
| | thickness of | of first | Presence of | thickness of | coating | Presence of |
| | the first | coating | Gradation | first coating | layer area | Gradation |
| | coating layer | layer (%) | Electrode | layer | (%) | Electrode |
| Embodiment | 2.1 | 25 | ◯ | 2.1 | 25 | ◯ |
| 1 | | | | | | |
| Embodiment | Less than 2 | 25 | ◯ | Less than 2 | 25 | ◯ |
| 2 | | | | | | |
| Embodiment | 2.1 | Less | ◯ | 2.1 | Less | ◯ |
| 3 | | than 20 | | | than 20 | |
| Embodiment | 2.1 | More | ◯ | 2.1 | More | ◯ |
| 4 | | than 30 | | | than 30 | |
| Embodiment | 2.1 | 25 | ◯ | — | — | X |
| 5 | | | | | | |
| Embodiment | — | — | X | 2.1 | 25 | ◯ |
| 6 | | | | | | |
| Comparative | — | — | X | — | — | X |
| Example | | | | | | |

### Experimental Example 1: Determine Capacity Retention Rate of All-Solid-State Battery

The capacity retention rate of 50 cycles was recognized for the all-solid-state batteries prepared in the Embodiments and the Comparative Examples. The capacity retention rate was calculated by performing 3 cycles of formation at 0.05 C and repeating the charge/discharge cycles at 0.2 C. Then, the discharge capacity at a first cycle is compared with the discharge capacity at 50-th cycle to calculate the capacity retention rate. The results are summarized in following Table 2.

TABLE 2

| | Capacity retention rate (%) |
|---|---|
| Embodiment 1 | 88 |
| Embodiment 2 | 73 |
| Embodiment 3 | 83 |
| Embodiment 4 | 82 |
| Embodiment 5 | 79 |
| Embodiment 6 | 82 |
| Comparative Example | 72 |

As recognized through the results shown in the above table 2, when the all-solid-state battery includes the gradation electrode including the second coating layer formed on the partial region of the first coating layer, the improved performance was shown in terms of the capacity retention rate. In particular, it was recognized that the durability of the electrode may be more increased during the preparing and driving of the electrode, when the second coating layer is formed only in the remaining region except for the region for concentrating the pressure applied by the jig.

As described above, according to the present disclosure, the electrode for the all-solid-state battery has the structure in which two coating layers of the first coating layer and the second coating layer are sequentially stacked on the current collector. During the battery assembling and driving, the all-solid-state battery has the structure in which only the first coating layer is selectively formed in the region for concentrating the pressure. Accordingly, the surface pressure may be minimized during the battery assembling and driving, thereby preventing the degradation of the surface characteristic of the all-solid-state battery and the dendrite of the all-solid-state battery, such that the durability and the performance of the all-solid-state battery is improved.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An electrode for an all-solid-state battery, the electrode comprising:
a current collector;
a first coating layer formed on the current collector; and
a second coating layer formed on a partial region of the first coating layer.

2. The electrode of claim 1, wherein a region that has no second coating layer but has the first coating layer is surrounded by a region having the second coating layer.

3. The electrode of claim 1, wherein a ratio of a thickness of the second coating layer to a thickness of the first coating layer is in a range from about 1% to 5%.

4. The electrode of claim 1, wherein a ratio of an area of the region having the second coating layer to an area of the region having the first coating layer is in a range from about 60% to 90%.

5. The electrode of claim 1, wherein a ratio of a loading level of an electrode active material of the second coating layer to a loading level of an electrode active material of the first coating layer is at least about 2%.

6. The electrode of claim 1, wherein the first coating layer comprises an electrode active material, a binder, and a solid electrolyte.

7. The electrode of claim 1, wherein the second coating layer comprises an electrode active material, a binder, and a solid electrolyte.

8. The electrode of claim 1, wherein a pressing member is placed on a region having no second coating layer of the electrode.

9. An all-solid-state battery comprising:
an electrode for the all-solid-state battery according to claim 1; and
a solid electrolyte.

10. A method for preparing an electrode for an all-solid-state battery, the method comprising:
forming a first coating layer on a current collector (S1);
placing a mask on the first coating layer and forming a second coating layer (S2); and
removing the mask (S3).

11. The method of claim 10, wherein the mask comprises at least one material selected from the group consisting of polyethylene, polytetrafluoroethylene, and polyethylene naphthalate.

12. The method of claim 10, wherein the mask has a thickness ranging from about 5 μm to 50 μm.

13. The method of claim 10, wherein the S1 comprises:
coating and drying first coating layer slurry comprising an electrode active material, a conductive material, a binder, and a solid electrolyte on the current collector.

14. The method of claim 10, wherein the S2 comprises:
coating and drying second coating layer slurry comprising an electrode active material, a conductive material, a binder, and a solid electrolyte on the first coating layer.

15. A method for preparing an all-solid-state battery, the method comprising:
sequentially stacking the electrode for the all-solid-state battery according to claim 1, a solid electrolyte layer, and an opposite electrode; and
rolling a stack structure using a pressing member,
wherein the pressing member is placed on a region having no second coating layer of the electrode for the all-solid-state battery.

16. The method of claim 15, wherein the electrode for the all-solid-state battery is a positive electrode, and
wherein the opposite electrode is a negative electrode.

17. The method of claim 15, wherein the electrode for the all-solid-state battery is a negative electrode, and
wherein the opposite electrode is a positive electrode.

18. An all-solid-state battery comprising:
an electrode including a current collector, a first coating layer formed on the current collector, a second coating layer formed on a partial region of the first coating layer, and a conductive material layer formed on a partial region of the second coating layer, wherein the conductive material layer is configured to enhance the electrical conductivity between the second coating layer and the solid electrolyte;
a solid electrolyte layer positioned between the electrode and an opposite electrode; and
a pressing member configured to apply pressure to the electrode, wherein the pressing member is placed on a region of the electrode that lacks the second coating layer.

19. The all-solid-state battery of claim 18, wherein the conductive material layer comprises at least one material selected from the group consisting of carbon black, conducting graphite, ethylene black, and graphene.

20. The all-solid-state battery of claim 18, wherein the conductive material layer is selectively formed only in regions of the second coating layer that are in direct contact with the solid electrolyte layer.
